(19) United States
(12) Patent Application Publication
(10) Pub. No.: US 2011/0302009 A1
(43) Pub. Date: Dec. 8, 2011

(54) Referring, Lending, and Reselling of Digital Items

(76) Inventors: Ian W. Freed, Seattle, WA (US); Gregory M. Hart, Mercer Island, WA (US); Melissa C. Kirmayer, Seattle, WA (US); Steven Kessel, Seattle, WA (US)

(21) Appl. No.: 12/792,518

(22) Filed: Jun. 2, 2010

(51) Int. Cl. G06Q 30/00

(52) U.S. Cl. 705/14.16; 705/26.1

(57) ABSTRACT

Digital items may be referred, lent, or resold via a computing architecture that supports a secondary market for such items, as well as the economic models to support the secondary market. In one scenario, a lender may lend a digital item to another person, and if that person purchases the digital item following a trial period, the lender is given a referral fee. In another scenario, rights holders of one digital item are paid a referral fee for any sales of other digital items that arise due to purchasers acting on a reference contained in the digital item.

### BACKGROUND

A large and growing population of people enjoys entertainment through consumption of digital content items, such as music, movies, images, books and other types of digital content. Many people today consume digital content through a wide variety of electronic devices. Among these electronic devices are electronic book readers, cellular telephones, personal digital assistants (PDAs), portable media players, tablets, netbooks, and the like.

As more content is made available in digital form, the economic landscape for content creation, production, and distribution is evolving. This is particularly the case for digital music and electronic books (or “eBooks”). Such content items may be distributed online to electronic devices, without production of a portable physical medium, such as a tape cassette, CD, or physical paper-based book. As a result, many of the transaction costs associated with traditional channels of distribution on physical media are being reduced or eliminated entirely. This leads to the possibility of new economic models involving referring, lending, and reselling of digital items.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architecture of computers and networks in which various models for lending of digital items, along with payment of referral fees for any conversion of lent items to purchased items, may be implemented.

FIG. 2 shows an electronic book reader device with a lending user interface to facilitate user lending of a digital item, such as an electronic book.

FIG. 3 shows a portable communication device with a loan acknowledgement user interface to facilitate affirmative acknowledgement by a recipient user to accept the digital item being lent.

FIG. 4 illustrates another architecture of computers and networks in which various models for resale of digital items, along with distribution of fees associated with such sales, may be implemented.

FIG. 5 illustrates an example arrangement in which a resale market for digital goods is established.

FIG. 6 illustrates yet another architecture of computers and networks in which rights holders are allowed to create digital items that include references to other digital items in an effort to drive additional purchase of the other digital items.

FIG. 7 is a block diagram illustrating selected modules in the computing systems employed in the various architectures of FIGS. 1, 4, and 6.

FIG. 8 is a flow diagram of an example process of facilitating lending of digital items, such as electronic books, and paying referral fees when recipients purchase the digital items as a result of being lent the digital items.

FIG. 9 is a flow diagram of an example process of facilitating resale of digital items, such as electronic books, and allocating the proceeds among various stakeholders including a reseller and one or more rights holders.

FIG. 10 is a flow diagram of an example process of facilitating item-to-item referral, where one digital item contains referrals to other digital items, to entice further sales of the referred items.

### DETAILED DESCRIPTION

This disclosure describes various architectures and techniques in which digital items, such as electronic books (or “eBook”), may be loaned, referred, and resold. The architectures provide a functional environment to permit transfer of such digital items, as well as the economic models to support secondary markets. As one scenario, a user may be consuming a digital item, such as reading an eBook, and offers to lend that digital item to another user. The digital item may be provided in whole or in part to the second user for her to try. During this lending period, the lender may or may not have access to the digital item. If the second user likes the digital item and decides to buy it, a referral fee is paid to the lender. The referral fee may take any number of forms, such as monetary (e.g., a portion of the sales revenue), credit for future purchases, points for an awards program, and so forth.

In another scenario, a user may wish to resell a digital item. When items are resold, a portion of the resale revenue is paid to the rights holders of the original work. As a result, a secondary market to facilitate resale of digital items is facilitated.

The architectures further support a referral economy that encourages authors and other rights holders to release works as digital items that reference other digital items for purchase. For instance, suppose an author releases a work in the form of an eBook. The author may include linked references to other eBooks so that when a reader activates the link and chooses to buy another eBook, the referring author may be paid a referral fee.

The digital items may be manifest in many different ways including, for example, as text-based items, audio items, video items, graphical items, and so forth. For discussion purposes, the architecture and techniques are described in the context of electronic books. The terms “electronic book” and/or “eBook,” as used herein, include electronic or digital representations of printed works (or portions of printed works), as well as digital content that may include text, multimedia, hypertext and/or hypermedia. Examples of printed and/or digital works include, but are not limited to, books, magazines, newspapers, periodicals, journals, reference materials, telephone books, textbooks, anthologies, instruction manuals, proceedings of meetings, forms, directories, maps, web pages, etc. However, certain concepts described herein are also applicable to other types of digital content items, such as music, audio books, video, and other content items that people watch, listens to, consume, or otherwise experience.

Further, eBooks are just one form of a common work. The work may also be released in other form, such as paperback, hardcover, and audio. If the work is currently only manifest in paper form (e.g., paperback or hardcover), the terms of the referral fee and/or resale arrangements may be provided to the rights holders as a way to entice publication of an electronic version of the common work, such as an eBook

### Architectural Environment

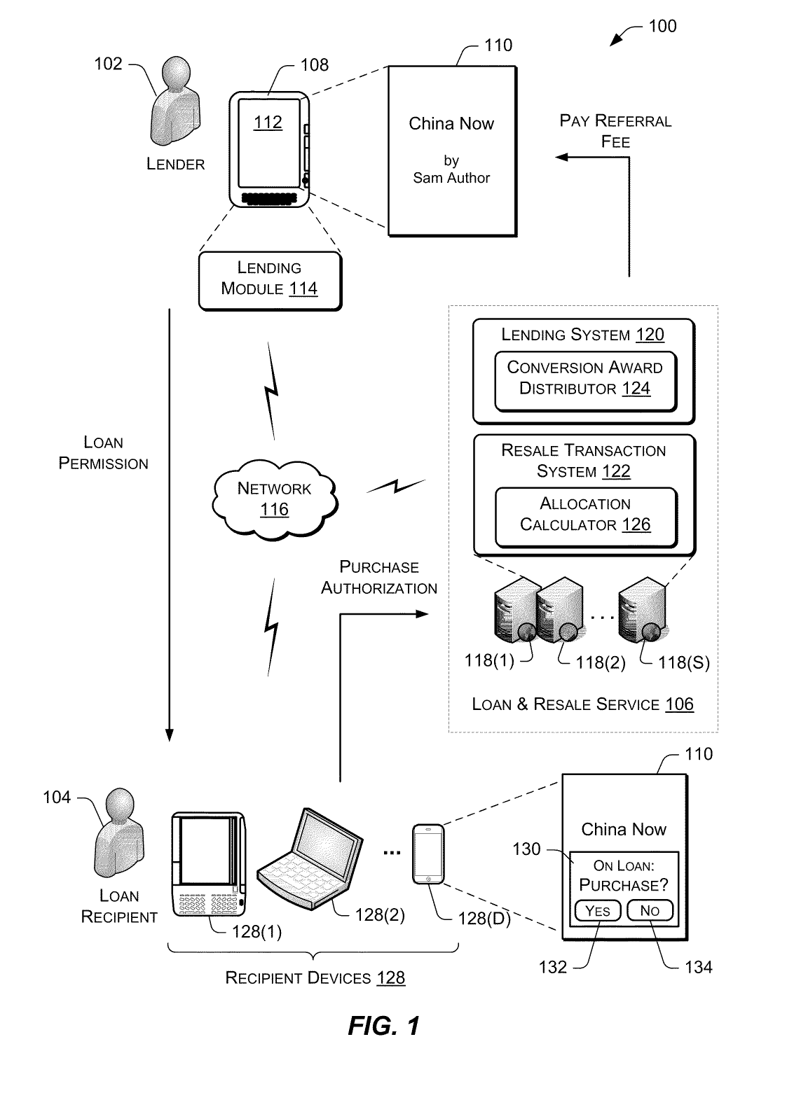

FIG. 1 shows an illustrative architecture 100 of computers and networks in which digital items, such as electronic books (or “eBook”), may be loaned, referred, and resold. The architecture 100 permits a first user 102 to loan or resell a digital item that the lender has previously purchased or otherwise owns. In some scenarios, the first user 102 loans the digital item for either a finite period or unlimited time, to a second user 104. In such scenarios, the first user 102 may also be referred to as a “lender” and the second user 104 may be referred to as a “loan recipient” or simply “recipient.” In other scenarios involving resale, the first user 102 may be referred to as the “reseller” and the second user 104 as a purchaser.

A loan and resale service 106 facilitates the lending and resale processes among the users. The users 102 and 104 may or may not have an account with the service 106. For loans, the service 106 maintains records that track which users have loaned which digital items to which other users, and for how long. For resales, the service 106 records data pertaining to resales of digital items, such as identifies of users involved in the transaction, identities of the digital items, and the dates.

The service 106 also facilitates the economic environment for loaning and reselling of digital items. In implementations pertaining to loaning, users are incentivized to loan digital items through payment of referral fees or other awards that are given when loan recipients elect to purchase the items being loaned. For instance, suppose the lender 102 lends an eBook to the loan recipient 104, as represented in FIG. 1 by the flow arrow labeled “Loan Permission.” After sampling the item, the loan recipient 104 decides to purchase the digital item, as represented by the flow arrow labeled “Purchase Authorization.” The loan and resale service 106 tracks this loan conversion and pays a referral fee (e.g., money, credit for future purchase, award points, etc.) to the lender 102, as represented by the flow arrow labeled “Pay Referral Fee.”

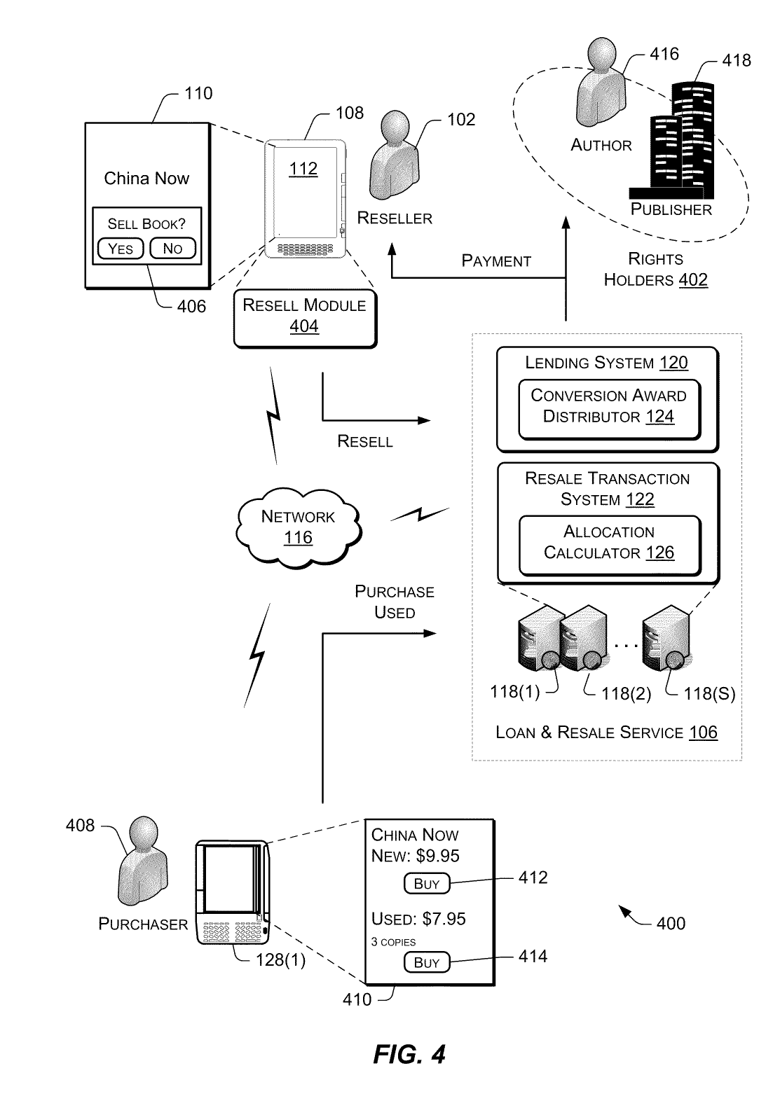

In other implementations pertaining to reselling, the service 106 allocates any proceeds from the resale among the reselling user and the rights holders (e.g., authors, publishers, distributors, etc.). The reselling users may be given monetary proceeds or awarded other units of value. The reselling implementations are described in more detail below with reference to FIG. 4. A more detailed discussion of the lending implementations is now provided with continuing reference to FIG. 1.

The first user 102 has an electronic device that facilitates consumption of a digital item. In this illustration, the electronic device is embodied as an electronic book reader device 108 that stores one or more eBooks, such as a fictitious eBook 110 titled “China Now” by a fictitious author named “Sam Author.” A front cover image of the eBook 110 is shown rendered on a display 112 of the device 108. The eBook reader device 108 is equipped with a lending module 114 that allows the lender 102 to lend eBooks to other users. The lending module 114 provides a user interface that may be rendered on the display 112 to facilitate the lending process. For discussion purposes, one example lending user interface will be described next before continuing with the description of the architecture 100 in FIG. 1.

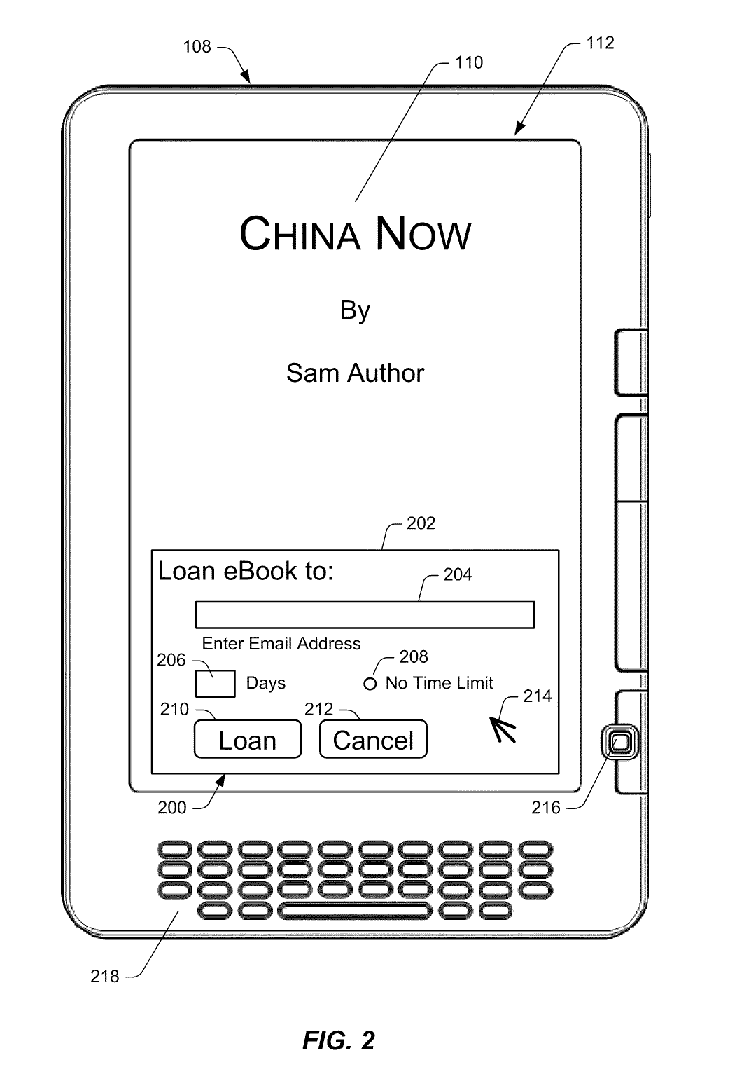

FIG. 2 shows the eBook reader device 108 with an illustrative lending user interface (UI) 200 to facilitate user lending of a digital item, such as the eBook 110. In this illustration, the lending UI 200 provides a panel 202 that is overlaid on the cover image of the eBook 110 (i.e., China Now), although other presentation layouts and formats may be used. The lending UI panel 202 may be invoked in many different ways, including through selection of an option from a menu to lend a book. The menu may be triggered from a home screen (not shown), in which the user is prompted to identify the digital item to lend, or from a local menu when a particular digital item is already selected.

The lending UI panel 202 includes a general instruction (e.g., “Loan eBook to:”) and an entry box 204 in which the lender may enter an identity of the party to whom the digital item is being loaned. In this example, the lending recipient is identified by an email address, although other conventions may be employed (e.g., person's name, account number, personal identifiers, etc.). The panel 202 may also include options for duration to lend the book. The options may permit selection of a finite period, as represented by an option 206 to enter a number of days to loan the item, or an indefinite period, as represented by an option 208 for no time limit. Other options may be presented, as well as other duration units (e.g., hours, weeks, months, etc.).

Once the lender enters the information, the lender may initiate the loan by selecting a soft “Loan” control 210 or cancel the process by selecting a soft “Cancel” control 212. A pointer 214 may be used to assist navigation through the lending UI 200, and the pointer may be controlled via a navigation mechanism 216. In this example, the navigation mechanism is a joystick, although other mechanisms may be used, such as a thumbwheel, touchpad, buttons, and so forth. The eBook reader device 106 further includes a keyboard 218 to facilitate entry of the intended recipient's identity in entry box 204. In other implementations, the display may include a touch responsive screen that facilitates user input via touch or touch proximity. In this implementation, the soft controls 210 and 212 may be selected via contact or proximity of a finger, stylus, or other pointing device (not shown).

With reference again to FIG. 1, the lending module 114 locally tracks which items have been loaned, the duration of the loan, and to whom the items have been loaned. For this example, suppose the lender 102 loans the eBook China Now to a loan recipient 104 for a one week period. The lending module 114 creates a record indicating that the eBook 110 is on loan to the user 104 for one week. In some implementations, the lender 102 may not be able to access the digital items that are being loaned out. In other implementations, the lender 102 may retain limited or unlimited rights to access the digital items while they are being loaned.

The lending module 114 provides the lending information to the referral and resale service 106 over a network 116. The network 116 is representative of any one or combination of multiple different types of networks, such as the Internet, cable networks, cellular networks, wireless networks (e.g., wifi, cellular, etc.) and wired networks. In one implementation, the eBook device 108 is equipped with wireless technology to connect with the service 106 at least partly over a wireless network.

As noted above, the referral and resale service 106 facilitates the lending process by monitoring loans made between users. The users may or may not have an account with the service 106. The service 106 maintains records that track which users have loaned which digital items to which other users, and for how long. The referral and resale service 106 is illustrated as being hosted on servers 118(1), 118(2), . . . , 118(S), which collectively have processing and storage capabilities to perform a myriad of operations pertaining to facilitating loan and resale of digital items, and the associated economic environment. The servers 118(1)-(S) may be embodied in any number of ways, including as a single server, a cluster of servers, a server farm or data center and so forth, although other server architectures (e.g., a mainframe architecture) may also be used.

The referral and resale service 106 may include a lending system 120 and a resale transaction system 122 hosted on the servers 118(1)-(S). The lending system 120 facilitates and tracks lending among users. The lending system 120 includes a conversion award distributor 124 that tracks when loan recipients elect to purchase the digital items following a trial during the loan period and awards referral fees to the lenders of items that influenced sale conversions. The resale transaction system 122 supports a market environment for resale of digital items. The resale transaction system 122 has an allocation calculator 126 to handle distribution of proceeds from resales among the reseller, one or more rights holders, and market facilitator.

The loan and resale service 106 may further support online retailing (e.g., via a website) of digital items, such as eBooks, and may facilitate electronic distribution of the digital items. In some implementations, the servers 118(1)-(S) store the items, although in other implementations, the servers merely facilitate publication, purchase, and delivery of the digital items.

The loan recipient 104 may utilize any number of electronic devices 128 to receive and consume the digital items being lent by the lender 102. In some cases, as illustrated here, the recipient devices 128 may be different than the lender's device 108. In this example, the recipient devices 128 are capable of storing and presenting the eBook 110. Representative devices 128 are illustrated as including another version of a dedicated eBook reader device 128(1), a notebook computing device 128(2), and a portable multi-function communication device 128(D). The computing device 128(2) and communication device 128(D) are implemented with a reader application or are otherwise able to receive and render the eBook 110.

Although three representative devices are shown, many other devices may be used, including desktop computers, tablets, PDAs, portable media players, entertainment devices, netbooks, gaming consoles, DVD players, media centers and the like. In some cases, the client devices 128 are capable of allowing the readers to access the service 106 over the network 116, browse various item titles, download samples, order items, receive lent items, and authorize payment for items being purchased. In this manner, the service 106 facilitates shopping, purchase, and/or delivery of eBooks and other content items for the various recipient devices 128. In addition, the service 106 may also track the manner through which the recipient device 128 accesses or obtains the content. For example, the eBook service may track that a recipient device 128 downloaded the content via a wired connection to a PC or via a wireless connection to an eBook reader.

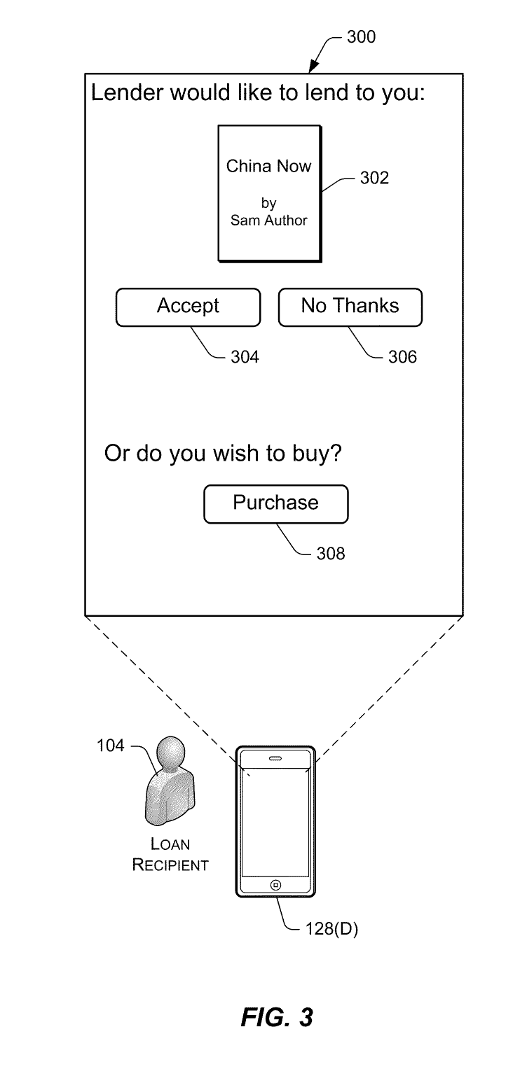

In some implementations, the recipient 104 is given the opportunity to accept the item being lent by the lender 102. Before the eBook China Now is transferred in whole or in part to the recipient device 128(D), the recipient may be prompted to affirmatively accept the eBook. One example UI is shown in FIG. 3, which will now be described before completing the discussion of FIG. 1.

FIG. 3 shows the portable communication device 128(D) with a loan acknowledgment UI 300 to facilitate affirmative acknowledgement by a recipient user to accept the digital item being lent. The loan acknowledgement UI 300 is presented on the display of the device 128(D) in response to receiving an offer to loan a digital item from the lender 102. In this illustrative example, the UI 300 includes a greeting (e.g., “Lender would like to lend you:”) and a reference to the digital item being offered. Here, the digital item is the eBook China Now and the reference is a thumbnail image 302 of the front cover of the eBook. Beneath the image 302 are two buttons. An “accept” button 304 may be selected if the recipient wants to accept the loaned item, and a “no thanks” button 306 may be elected if the recipient does not want the loaned item.

The UI 300 may further give the recipient an immediate opportunity to purchase the item being offered. In this example, the UI 300 includes a “purchase” control button 308 that may be selected to purchase the eBook, rather than receiving a lent eBook. For purposes of ongoing discussion, suppose the recipient 104 elects to accept the offer to be lent the eBook China Now by selecting the control 304. In response, all or part of the eBook is transferred to the device 128(D).

With reference again to FIG. 1, when all or a portion of the loaned eBook 110 is downloaded from the service 106 (or directly from the eBook device 108), in one embodiment, it is stored locally on the recipient device 128 for subsequent access by the loan recipient 104. Parts of this transmission, including the last segment to the recipient device 128, may be over a wireless connection. When the user selects to read this eBook, the contents are rendered on the device. In FIG. 1, a cover image 110 of the loaned eBook China Now is shown rendered on a display of the communication device 128(D).

Sometime during the loan period, the recipient 104 is given opportunities to purchase the eBook and return the loaned eBook to the lender 102. In FIG. 1, a sale conversion UI 130 is presented atop the eBook cover image 110 to ask whether the user 104 is interested in purchasing the eBook. In this simple and illustrative sale conversion UI 130, the recipient 104 is presumed to have an account with the service 106 and may simply purchase the eBook via selection of a “yes” button 132 or reject the offer by selecting a “no” button 134. In situations where the user does not have an account, a more sophisticated UI may be provided that allows the recipient 104 to enter account and payment information.

Once the recipient authorizes purchase of the eBook, a purchase request is submitted to the referral and resale service 106 which either delivers the eBook to the recipient's device 128 or arranges for delivery of the eBook. Further, the service 106 determines that the purchase came as a result of the eBook being lent by the lender 102. More particularly, the lending system 120 ascertains who lent the eBook 110 to the recipient that formed the basis for the sales conversion. The identity of the lender may be included in the purchase request from the recipient, or it may be extracted from records maintained at the service 106.

The conversion award distributor 124 determines what type of referral fee should be awarded to the lender 102. The referral fee may be a monetary amount, credit to be applied to future purchases, points in an award program, or something else of sufficient value to the lender to encourage the lending behavior. The amount or quantity of the referral fee may vary based on any number of factors, such as cost of the digital item, newness of the digital item, sales ranking of the digital item, number of other forms of the common work from which the digital item is derived, status of the lender, status of the recipient, sizes of the digital item being purchased, and so forth. Still further, other factors that may play into the referral fee calculation include how the digital item is being consumed by the lender or recipient. For example, if the recipient device 128 is a netbook or computing device that downloads the eBook via a wifi connection, the referral fee may be increased slightly as the cost to distribute the eBook was less than it would have been if it had been delivered to an eBook reader over a cellular connection. In another situation, the referral fee may be increased if the eBook is being consumed on an eBook reader device to encourage purchase of such devices.

While the loan and referral service 106 is described above as including the lending system 120 and resale transaction system 122, in alternative embodiments some or all of the components of the service 106 may be separate. For example, the lending system 120 may be provided by a different entity than the resale transaction system 122. In a similar manner, functions of each system may be distributed. For example, the lending system 120 and/or resale transaction system 122 may be implemented by multiple parties.

FIG. 4 shows an illustrative architecture 400 of computers and networks in which digital items may be resold and revenues allocated. The architecture 400 permits the first user or reseller 102 to resell a digital item that the lender has previously purchased or otherwise owns. The loan and resale service 106 facilitates the reselling process by tracking the offers to resale and allocating proceeds to interested parties, including the reseller 102, the service 106, and various rights holders 402.

To provide an example context, suppose the reseller 102 decides to resell the eBook 110 entitled China Now. The eBook reader device 108 is equipped with a resell module 404 that allows the reseller 102 to resell eBooks to other users via an online marketplace or directly in one-to-one sales. The reselling module 404 provides a user interface 406 that may be rendered on the display 112 to facilitate the lending process. In this simple example, the resell UI 406 simply prompts the reseller 102 with whether he or she wishes to sell the eBook 110. Two controls—“yes” and “no” controls—are provided to allow the reseller to initiate reselling of individual eBooks or other digital items.

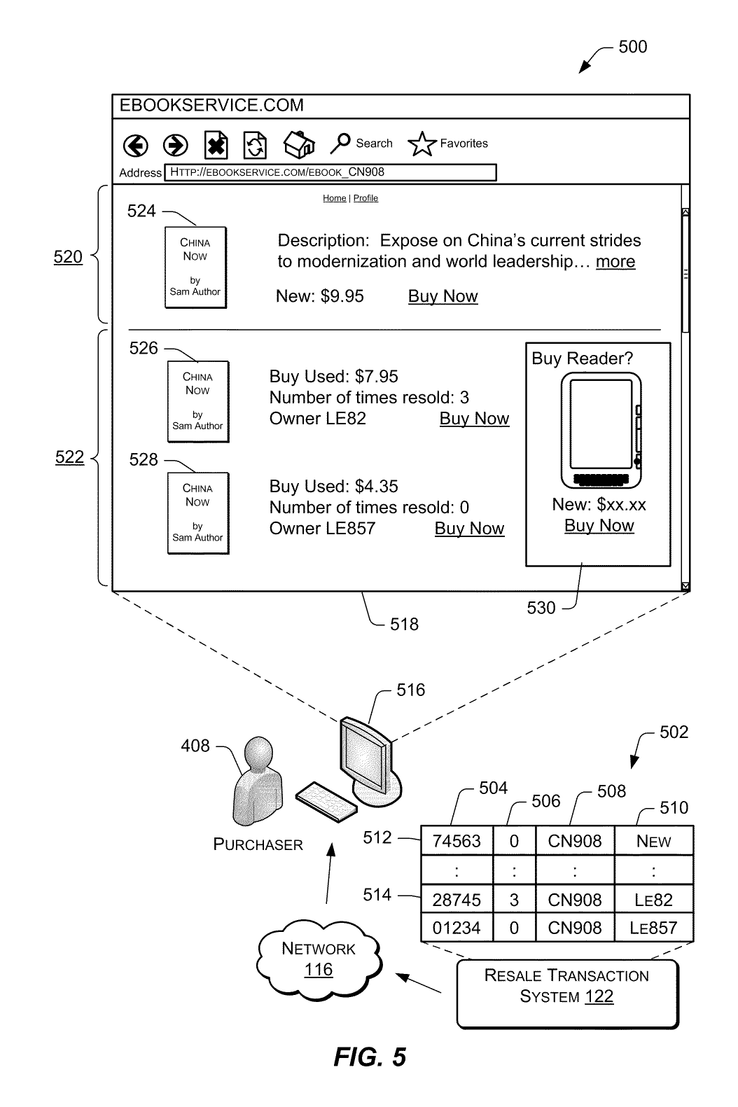

Upon election of the “yes” control in the UI 406, the reseller initiates resell of the eBook 110 and an authorization to resell the eBook is given to the loan and resale service 106, as represented by the flow arrow labeled “Resell.” The eBook may be removed or disabled at that point from the local memory of the device 108, or kept fully operational until a point of sale is consummated. The service 106 may list the eBook along with new versions of the eBook and other used eBooks. Resale is described below in more detail with reference to FIG. 5.

Another user 408 uses an eBook device 128(1) to browse the service 106 (or other eBook retailers) for various eBooks. New eBooks are provided at one price, while the “used” eBooks attempting to be resold are offered at lower and varying prices. As shown in FIG. 4, a UI 410 is provided on the recipient device 128(1) to offer both a new and used option of the eBook China Now. The new version is priced at $9.95, while the used version is priced at $7.95. These prices are merely illustrative, and are not intended to set a range or relationship. The prices may be higher or lower, and may have a much greater disparity. The UI 410 provides “Buy” controls 412 and 414 to allow user selection of the new or used eBook options. For discussion purposes, suppose the purchaser 408 elects to buy a used eBook by selecting the “Buy” control 414. A purchase request is sent to the service 106, as represented by the flow arrow labeled “Purchase Used.”

The resale transaction system 122 determines who owns the used eBook. The identity of the reseller may be ascertained by association with a unique serial number of the used eBook. Additionally, the resale transaction system 122 identifies appropriate rights holders of the common work from which the eBook is derived. The allocation calculator 126 computes various allocation portions resulting from the resale, and pays that out to the various stakeholders including the reseller 102 and one or more rights holders 402. This is represented by the flow arrow labeled “Payment.”

As shown here, the rights holders 402 may include at least an author 416 and/or a publisher 418. In general, a rights holder 102 may be any person or entity that holds or has rights to reproduce, distribute, import, export, create derivatives, perform or display publicly, sell or transmit the content. In some instances, there may be more than one rights holder for the content (e.g., a publisher may have rights to distribute the content in certain countries, while the author retains the rights to distribute the content in other countries; or publisher A may have the rights to distribute a book in printed form and publisher B may have the rights to distribute a book in eBook form). Examples of rights holders for various types of digital content include, but are not limited to, authors, publishers, music labels, movie studios, artists, songwriters, performers, heirs, and delegates.

The allocation portions among the reseller 102, rights holders 402 and service 106 may vary based on any number of factors, such as cost of the digital item, number of times it has been resold, age of the item, and so forth. The service 106 may be allocated more depending upon cost of holding, marketing, and transferring the used eBook. For example, delivery over a cellular network may cost more than delivery over a wifi connection or the Internet.

FIG. 5 shows one example arrangement 500 of how the resale transaction system 122 establishes a resale market for digital items, such as eBooks. The resale transaction system 122 tracks offers by resellers to resell their eBooks. In this example, the system 122 maintains a database table 502 that stores various information about each eBook that is put on the market. The table 502 includes an eBook identity field 504 that contains unique identifiers for each eBook that is distributed, a field 506 that contains the number of times the eBook has been resold, a work identity field 508 to identify the common work from which the eBook was derived, and a user identity field 510 that contains a unique identifier for the reseller. In this example, the table 502 includes record 512 for a new eBook with an identifier 74563, which has been resold zero times, and is for the common work with an identifier CN908 (i.e., the eBook China Now). The table 502 also includes record 514 for a used eBook with an identifier 28745 for the same work with an identifier CN908 (i.e., the eBook China Now). The used eBook has been resold three times, and is owned by a user with the identifier LE82.

In FIG. 5, the purchaser 408 uses a computing device 516 to access an eBook retailer, which may be part of the service 106, over the network 116. The computer 516 may run a browser that requests and renders web pages to form an eBook sales UI 518. However, this is merely one possible implementation, and other technologies may be employed to facilitate an eBook sales UI 518.

The UI 518 has a primary screen area that is divided into two regions: a new eBook region 520 and a used eBook region 522. A demarcation line separates the two regions 520 and 522. In the new region 520, a thumbnail image 524 for the eBook China Now is presented, in association with at least a portion of the record 512 in the table 502. A description of the eBook is provided and a price for a new eBook. The price for the new eBook is set to $9.95. Other information may also be provided.

In the used region 522, two thumbnail images 526 and 528 are shown to represent that at least two used eBooks have been placed on sale. The first used eBook 526 was placed on sale by owner LE82 for a price of $7.95, per the record 514. The second used eBook 528 was placed on sale by owner LE857 for a price of $4.35. The UI 518 includes “buy now” controls associated with each version that allow the purchaser to select and purchase a particular one of the choices.

Also shown as part of the UI 518 is an opportunity to purchase an eBook reader device (or other content rendering device for other digital items). Perhaps the purchaser has primarily been reading eBooks on computing devices using a reader application, and would now like to purchase a dedicated reader device. The sales box 530 offers a new eBook reader device for a price, and a “buy now” control is provided to initiate a purchase.

Furthermore, in the scenarios described herein involving loaning or reselling of an eBook, there is an opportunity for the lender/reseller to be paid a referral fee or sale proceeds resulting from the action. In some implementations, the lender/reseller may be given further fees or awards if their activity induces the other party to purchase an electronic device, such as an eBook reader device. Thus, extra incentives may be built in to incentivize users to initiate actions that induce others to buy eBooks and eBook reader devices.

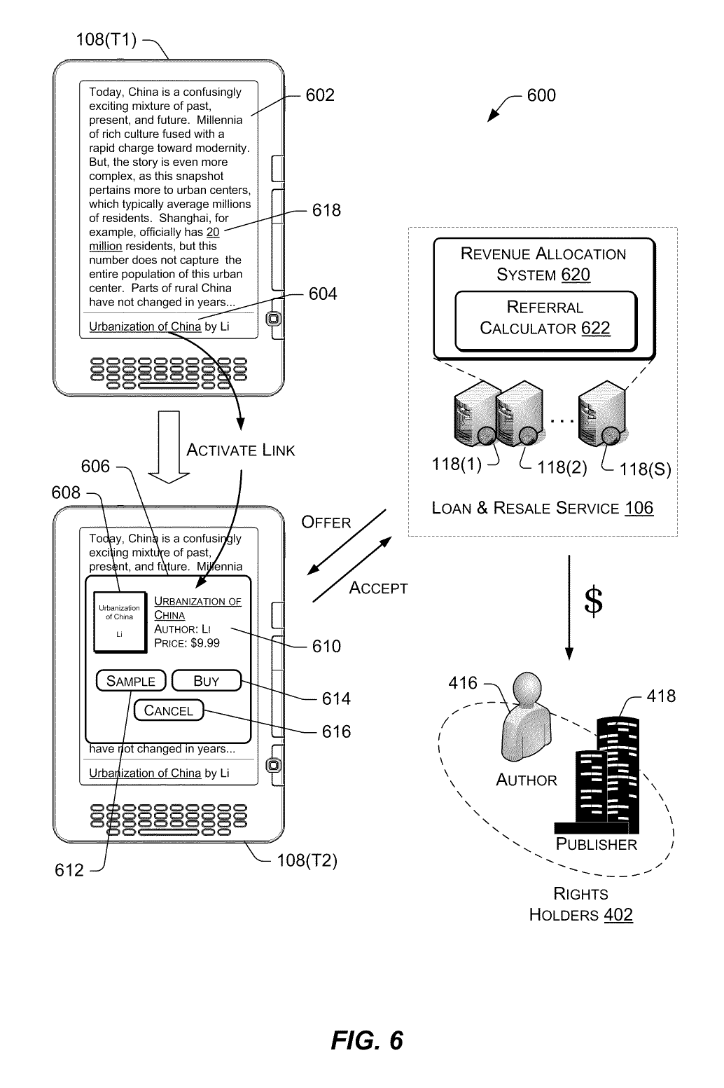

FIG. 6 shows another architecture 600 that supports a referral economy to encourage authors and other rights holders to release works as digital items that also reference other digital items. For instance, suppose an author releases a work in the form of an eBook. The author may include linked references to other eBooks or digital items so that when a reader activates the link and chooses to buy another eBook or digital item, the referring author may be paid a referral fee resulting from a portion of the sales revenue.

In FIG. 6, the architecture 600 includes the eBook reader 108 and the loan and resale service 106. Two instances of the eBook reader device 108 are illustrated to show different screen renderings at two different times T1 and T2. The first or upper instance of the device, which is labeled as 108(T1), is taken at a time T1 when the eBook reader is rendering a page or portion of an eBook 602. The author (or other rights holders, such as a publisher) releases the eBook 602 with references to other works. In this example, the eBook 602 includes a reference 604 to another eBook entitled Urbanization of China. The reference also forms a link that upon actuation, launches a user interface for the referenced work that contains more information and an offer to sample or buy the eBook.

One illustrative user interface 606 is shown rendered on the second or lower instance of the eBook reader device, which is labeled as 108(T2). The referenced work UI 606 may be served from the loan and resale service 106 in response to the user activating the link 604 (as represented by the “offer” flow arrow), or it may be locally generated by the device 108. The referenced work UI 606 may include, for example, a thumbnail image of the cover 608, information 610 about the referenced eBook such as author name and price, and various options to sample or buy the eBook. Here, a “Sample” control 612 allows the user to sample a portion of the referenced work, a “Buy” control 614 may be used to purchase the referenced work, and a “Cancel” control 616 is provided to allow the user to close the UI 606 and return to reading the eBook 602.

In one implementation, the eBook 602 is formed as a dynamically populated electronic item that generally includes some static information (e.g., text, images, audio, video, etc.) and one or more dynamic fields, which are configured to be dynamically populated from a source separate from the electronic item. In FIG. 6, for example, the rendered portion includes static text and a dynamic field 618 that notes the population of Shanghai. Since this population number can change over time, the field may be repopulated to keep the eBook more up-to-date with the current population figures. In some instances, the dynamic electronic items may be made up entirely of dynamic fields, and may be free of any static information. As a result, dynamic electronic items can change over time as the dynamic fields are populated and/or repopulated from time-to-time.

With a dynamic electronic item, references to other works may be added or changed periodically as part of the repopulation. Thus, the link to the eBook Urbanization of China may be later changed to another eBook. In this manner, the rights holders may continue to refer readers to a wider collection of other eBooks or digital items. Dynamic electronic items are described in more detail in U.S. patent application Ser. No. 12/060,114, entitled “Dynamically Populating Electronic Item”, which was filed on Mar. 31, 2008, and is hereby incorporated by reference.

For discussion purposes, suppose that the user elects to purchase the eBook or other digital item referred by the eBook 602 by selecting the “Buy” control 614. The eBook submits a purchase request to the loan and resale service 106 (as represented by the “accept” flow arrow) and in response, the service 106 either transfers the eBook to the eBook reader device 108 or directs another service (e.g., e-commerce retailer) to provide the eBook. The purchase request includes information that the purchase resulted from a referral found in the eBook 602.

The loan and resale service 106 includes an item-to-item referral system 620 that determines revenue allocation for proceeds from the sale of the referred digital item. A portion of the proceeds may be paid to the rights holders 402 of the purchased digital item, such as the eBook titled Urbanization of China. Additionally, a portion of the proceeds may be paid to the rights holders 402 of the referring digital item, such as eBook 602, which contained the reference to the purchased digital item. The item-to-item referral system 620 has an allocation function/calculator 622 that computes allocation portions of the revenues among the rights holders of the referring digital item (e.g., eBook 602) and of the digital item being purchased. This revenue allocation is represented by the “$” flow arrow.

This referral economy may prove to be an effective marketing tool to drive sales of digital items. As one scenario, the referring digital item may be an eBook that includes a reference to an audio version of the eBook or a movie derived from the same root work. As another scenario, publishers may release digital items with references to other digital items which the publishers have an interest. As yet another scenario, an author may reference other digital items from a series of works.

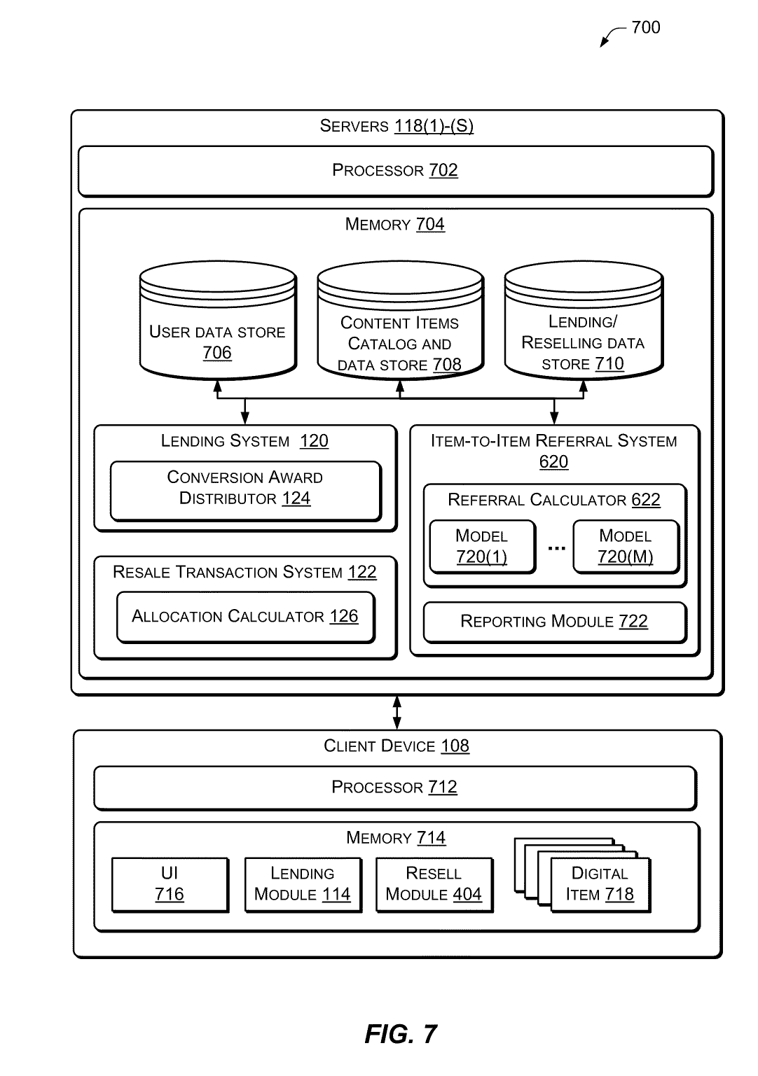

FIG. 7 shows selected modules in a representative computer system 700 that may be used to functionally support practices of referring, lending, and reselling of digital items, as described above with respect to architectures 100, 400, and 600. The system 700 includes the servers 118(1)-(S) of the loan and resale service 106 and any of the electronic devices 108 and 128(1)-(D), as represented by a client device 108. The servers 118(1)-(S) collectively provide processing capabilities 702 and memory 704. The memory 704 may include volatile and nonvolatile memory and/or removable and non-removable media implemented in any type or technology for storage of information, such as computer-readable instructions, data structures, program modules or other data. Such memory includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems or any other medium which can be used to store the desired information and which can be accessed by a computing device.

Stored in the memory 704 are multiple data stores, including a user data store 706, a content items catalog and data store 708 and a lending/reselling data store 710. The user data store 706 maintains user data for users of the service 106, such as users 102 and 104. User data may be established in response to users registering or subscribing with the service 106 or simply visiting an online site associated with the service 106, such as a retail site.

The content items catalog and data store 708 maintains a catalog of digital items, such as music, eBooks, movies, and so on. Additionally, the content items catalog and data store 708 may further store the digital items themselves that can be downloaded to the client device 108. In this manner, when the client device 108 accesses the servers 118(1)-(S), the user is able to browse the catalog for various content items and then purchase and download that content item from the content items catalog and data store 708. In other implementations, the servers 118(1)-(S) may support the catalog, but facilitate delivery of the content items through other mechanisms.

The lending/reselling data store 710 stores data pertaining to lending and resale activities, such as identities of the users, the users' devices, the digital items, and the terms of the loan or resale. The lending/reselling data store 710 may store this information as records in a table that associates such data for individual transactions, as illustrated by the table 502 in FIG. 2.

The client device 108 has a processor 712 and memory 714 (e.g., volatile, non-volatile, etc.). A user interface (UI) 716 is stored in the memory 714 and executed on the processor 712 to allow the client device 108 to access the servers 118(1)-(S) of service 106 and request various content items. In one implementation, the UI 716 is a browser or other application that renders pages or content served by the servers 118(1)-(S).

The lending module 114 introduced in FIG. 1 is shown stored in memory 714 and is executable on the processor 712 to facilitate lending of digital items to another user. In one implementation, the lending module 114 may direct the electronic transfer of the digital item from the client device 108 to another device, such as over a peer-to-peer wireless connection or through a physical connection. In another implementation, the lending module 114 directs the loan and resale service 106 to provide a loan version of the digital item.

When a user loans a digital item, the lending module 114 collects data pertaining to the transaction. The data includes an identity and metadata of the digital item, identities of the lender and recipient, identities of the electronic devices used by the lender and recipient, and duration of the loan. A record associating this information is created and stored locally on the client device 108. Further, this lending record may be passed to the servers 118(1)-(S) for use in determining a referral fee to be paid to the lender on any conversion of the loaned copy to a purchased copy.

The lending module 114 may further play a role in establishing and/or enforcing digital rights management. For instance, lending module 114 may dictate and enforce what access rights the lender retains for the digital item that is on loan to another user. In one implementation, the digital item may be temporarily removed from the client device 108 and maintained by the service 106. In another implementation, the digital item may be retained on the client device 108, but disabled from use. In still other implementations, the digital item may be fully or partially accessible even while it is on loan.

The resell module 404 introduced in FIG. 4 is also stored in memory 714 and facilitates resale of digital items. When a user wishes to resell a digital item, the resell module 404 helps the user draft and submit an offer to sell the digital item. The resell module 404 also creates a resale data record that contains an identity of the digital item and an identity of the seller.

One or more digital items 718 may be stored in the client device 108. The digital items may be ones that the user purchased or otherwise acquired, and hence belong to the owner. Additionally, there may be digital items that are currently on loan, and hence temporarily stored or accessible by the client device 108. One or more rendering engines (not shown) may also be stored at the client device 108 in memory 714. These rendering engine(s) enable the user to experience any of the digital items 718. For instance, one type of rendering engine is an eBook reader application that facilitates display/presentation of a digital eBook or other text-based content items. Other types of rendering engines may include an audio player to play music or other audio-based content items or a video player that enables playback of video or other video-based content items. The rendering engine may also be a multimedia player, allowing playback of multiple types of content items.

In the implementation of FIG. 7, the lending system 120, the resale transaction system 122, and the revenue allocation module 620 are software-enabled systems that reside in the memory 704 and execute on the processor 702. The lending system 120 tracks lending events where one user lends a digital item to another. The lending system 120 collects the lending records created by the client-side lending module 114 to monitor which items are being lent and the parties involved. The lending system 120 may further set and control the access rights for the digital item for both the lender and the recipient. When the user decides to purchase the digital item after sampling the lent item, the lending system 120 receives the purchase request directly, or receives notice that a purchase is being made. In response, the lending module informs the lender and restores all rights to the digital item.

Further, the lending system 120 pays a referral fee to the lender since the act of lending the digital item enticed the recipient to purchase the digital item. The lending system 120 includes a conversion award distributor 124 that computes the referral fee to be awarded. The fee may be a monetary amount, such as a portion of the sale proceeds. The fee may alternatively be in the form of credit or discounts to future purchases made by the lender. Further, the fee may be some form of non-monetary awards, such as points that may be redeemable for various awards.

The resale transaction system 122 tracks resale events where a user offers to resell a digital item. The lending system 122 collects the resale records generated by the client-side resell module 404 to track which items are being offered for resale. The lending system 122 may maintain tables of this information, such as table 502 of FIG. 5, which are stored in the lending/reselling data store 710. The digital items may be resold in a private one-to-one transaction, or through a retailer. The resale transaction system 122 helps establish the secondary market.

Further, the resale transaction system 122 has an allocation calculator 126 to handle distribution of proceeds from sales of the digital items. The proceeds may be split among the reseller, one or more rights holders, and a market facilitator. While the rights holders may get less for the resold digital item in comparison to a first time sale, the secondary market may still provide an additional revenue stream for the rights holders.

The item-to-item referral system 620 is implemented on the servers 118(1)-(S) to monitor sales generated through referrals from other digital items. The referral system 620 tracks user requests for information about digital items, where the requests were originated through links provided in other digital works. If the user decides to purchase the referenced digital item, the referral system 620 captures that event and pays a referral fee to the rights owners.

The item-to-item referral system 620 has an allocation function/calculator 622 that allocates sales proceeds according to one or more allocation models 720(1), . . . , 720(M). Each of the allocation models 720(1)-(M) determines various splits among the rights holders for such referrals. The item-to-item referral system 620 may further include a reporting module 722 that compiles information pertaining to revenue receipts and allocation calculations performed by the referral function/calculator 622. The reporting module 722 may be configured to generate periodic reports containing the information and distributing those reports to the rights holder(s) 102. Alternatively, the reporting module 722 may provide the information in real-time to a requesting rights holder 102 via a user interface, such as a browser-based interface. In this manner, the rights holder 102 may access up-to-date information pertaining to revenue allocation at any time by simply accessing the loan and resale service 106 over a network from a computer.

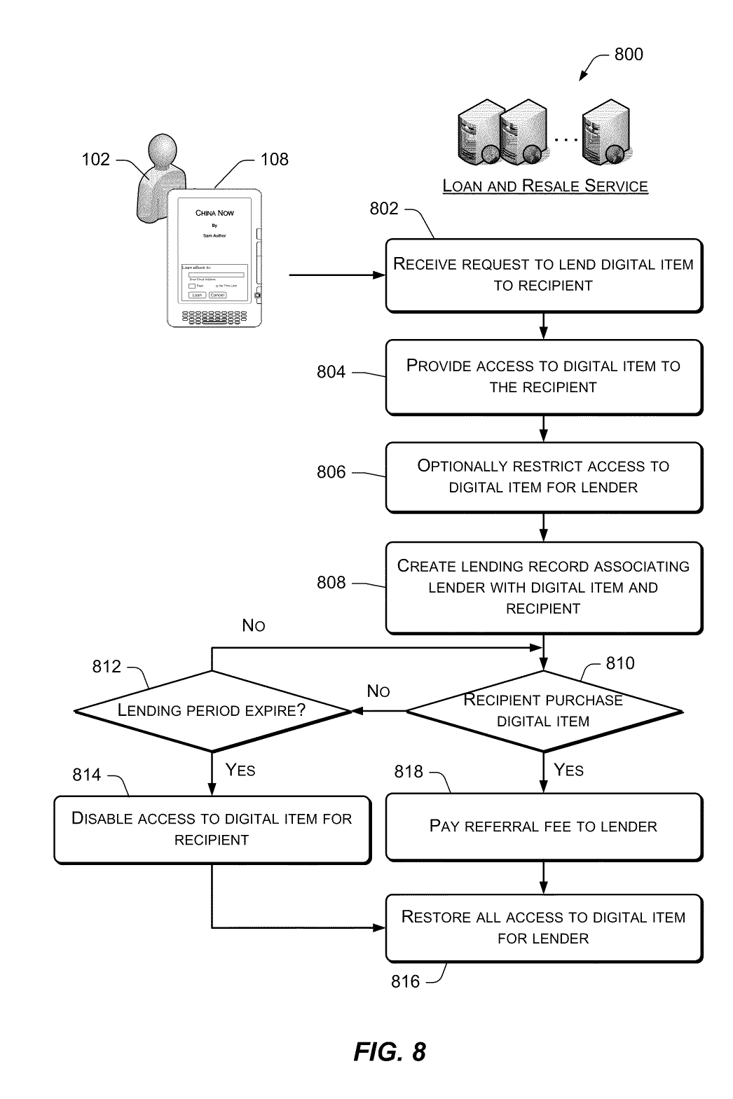

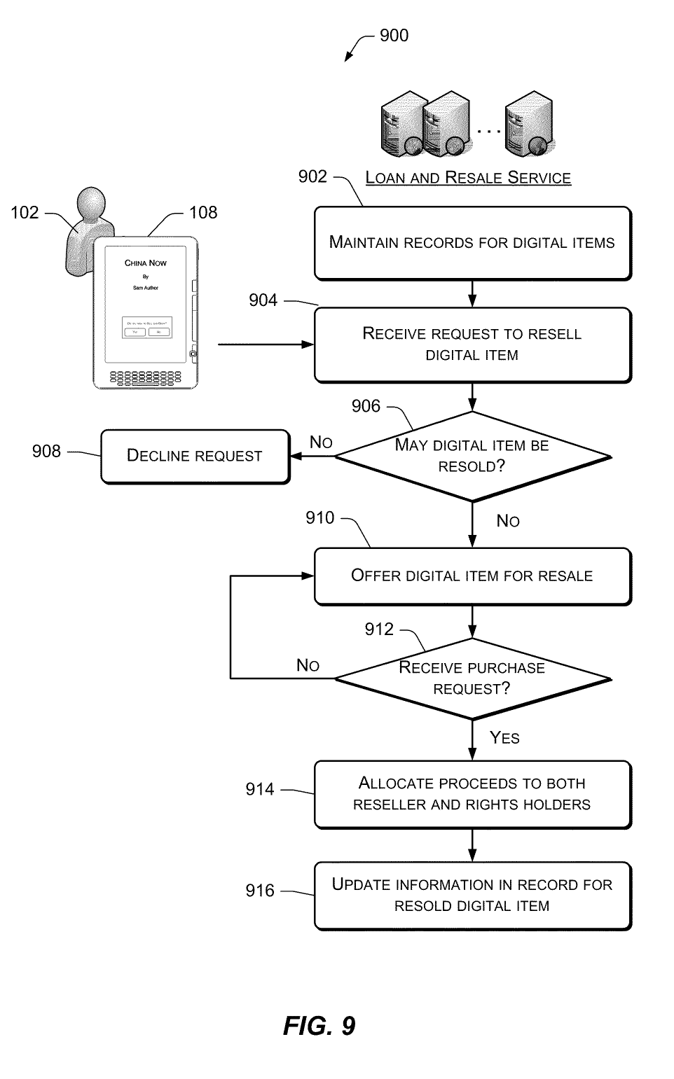

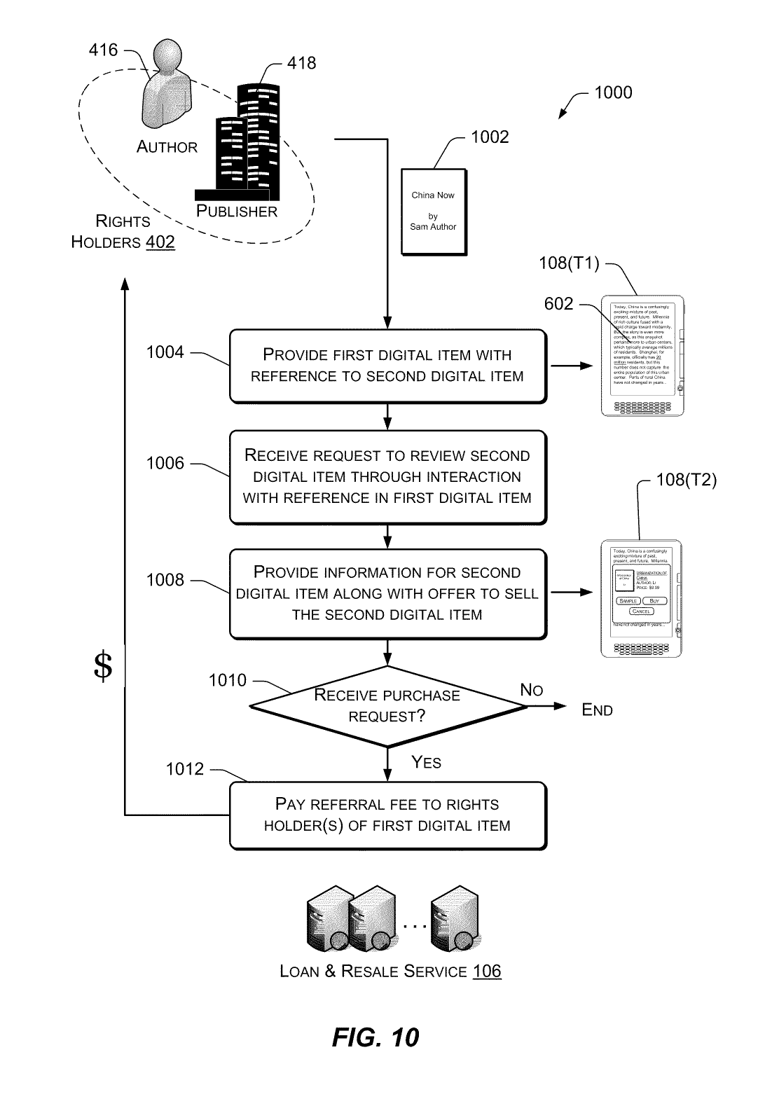

FIG. 8 shows a general process 800 of facilitating lending of digital items, such as eBooks, and paying referral fees when recipients purchase the digital items as a result of being lent the digital items. The process 800 (as well as processes 900 and 1000 in FIGS. 9 and 10 respectively) is illustrated as a collection of blocks in a logical flow graph, which represent a sequence of operations that can be implemented in hardware, software or a combination thereof. In the context of software, the blocks represent computer-executable instructions that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation, and any number of the described blocks can be combined in any order and/or in parallel to implement the process.

For discussion purposes, the process 800 is described as being performed by the loan and resale service 106 in the architecture 100 of FIG. 1. Additional reference may be made to the computing system 700 in FIG. 7.

At 802, a request to lend a digital item to a recipient is received from a lender 102. In one implementation, the eBook reader device 108 provides a lending UI that allows the user to designate a recipient to lend the digital item. Continuing the example from FIG. 1, suppose the lender 102 lends the eBook China Now to a recipient.

At 804, access to the digital item is provided to the recipient. In some implementations, the service 106 provides the digital item to the recipient and the recipient is permitted to enjoy full and unlimited access to the digital item. In other implementations, restrictions may be applied to the digital item so that the recipient is not granted full, unlimited access to the digital item being lent. Such restrictions may be time-based, content limited (i.e., only a portion is provided), or both.

At 806, the lender's access to the digital item may be optionally restricted. Similar to loaning a physical item, such as a book, the lender may optionally be prevented from consuming the digital item while it is being lent.

At 808, a lending record is created to track identities of the lender, the recipient and the digital item being loaned. The lending record may be stored at the service 106, such as the lending/reselling data store 710.

At 810, the service 106 monitors whether the recipient purchases a new version of the digital item following review of the loaned version. If the recipient does not buy the digital item (i.e., “no” branch from 810), the service determines whether the lending period has expired at 812. The lending period may be of any finite duration (e.g., day, week, month) or it may be indefinite. In the latter case, the digital item is considered loaned to the recipient until the recipient expressly returns the digital item. As long as the period has not expired, the service will continue to monitor whether the recipient purchases the digital item, as represented by the “no” branch from 812. If the lending period expires (i.e., the “yes” branch from 812), the recipient's access to the digital item is disabled at 814 and the lender's access is fully restored (to the extent it was ever restricted) at 816.

Returning to 810, if the recipient decides to purchase her own version of the digital item (i.e., the “yes” branch from 810), a referral fee is paid to the lender at 818. In this scenario, the act of loaning the digital item resulted in a sale of the digital item, and hence the lender is awarded a fee. The fee may be monetary based, or non-monetary based. It may be a discount, a credit, points, or other award of value.

FIG. 9 illustrates a general process 900 for facilitating resale of digital items, such as electronic books, and allocating the proceeds among various stakeholders including a reseller and one or more rights holders of the underlying work. At 902, the loan and resale service 106 maintains records for digital items that are created and distributed. The records may be stored in the lending/reselling data store 710, and track information about the digital items. Example records 512 and 514 are shown in a table 502 of FIG. 5, which includes the count of resales 506.

At 904, a request to resell a digital item is received. In FIG. 9, the reseller 102 initiates a request to resell the eBook China Now through a UI rendered on the eBook reader device 108. This request includes an identity of the digital item, and an identity of the reseller 102. The request may have a requested resale price as well, although this may be set by the service.

At 906, the service 106 determines whether the digital item may be resold. In one approach, the digital rights management of the digital item may prohibit resale, and hence the reseller is prohibited from offering the digital item. In another approach, the service 106 uses the identity of the digital item contained in the request and examines the associated record pertaining to that digital item. If the digital item cannot be resold (i.e., the “no” branch from 906), the request to resell the digital item is declined at 908, and the reseller 102 is notified.

However, if the digital item can be resold (i.e., the “yes” branch from 906), the service 106 offers the digital item for resale either on its own resale site, or to another e-commerce entity at 910. The service or the seller may set the resale price, which is typically less than the original sale price.

At 912, the service monitors for any purchase requests from other buyers. The service will continue to wait (as indicated by the “no” branch from 912) until a sale is made, or the reseller ceases trying to resell the digital item. Once a purchase request is received (i.e., the “yes” branch from 912), proceeds from the resale are allocated to both the reseller and to any rights holders in the underlying work at 914. That is, unlike reselling a physical item (e.g., book) where no amount is paid to the rights holder of the underlying work, reselling a digital item results in a transfer of an item that is essentially identical to an original version. Thus, to establish a market, part of the proceeds is paid to the rights holders in the underlying work.

At 916, the information associated with the particular item is updated to reflect the resale. For instance, if the information pertains to a count of sales (i.e., column 506 in table 502), that count is changed to reflect the recent sale.

FIG. 10 illustrates a general process 1000 of facilitating item-to-item referral, where one digital item contains referrals to other digital items, to entice further sales of the referred items. In the illustrated example, rights holders 402 (e.g., author 416 and publisher 418) create and publish digital items that contain references to other digital rights. The digital items may further be distributed by a rights holder, or through the service 106 (as shown here), or through a third party ecommerce site. An eBook 1002 is shown being provided to the service 106 from the rights holders 402.

At 1004, a first digital item (e.g., eBook 1002) that references a second digital item (e.g., another eBook or other digital items such as audio items, video items, etc.) is provided. The first digital item is consumed by a user who is using an electronic device, as represented by the eBook 602 being rendered on an eBook reader device 108(T1).

At 1006, a request to review the second digital item is received. This request is generated by user interaction with the reference using the electronic device. As one example, the user may activate a link in the eBook 602 that references another digital item.

At 1008, in response to the request, the service 106 provides information about the second digital item to the user. The information may include a summary of the digital item, the creator's name, a publisher or distributor name, a price, reviews, and so forth. The service 106 may also provide an offer to sell the second digital item. As one example implementation, this information and offer may be presented in the form of a UI rendered on the electronic device, such as UI 606 shown in FIG. 6 and reproduced here as being rendered on device 108(T2).

At 1010, the service 106 monitors for a purchase request for the referenced or second digital item. If no request is received (i.e., the “no” branch from 1010), the process 1000 ends. If a purchase request is received (i.e., the “yes” branch from 1010), a referral fee is paid to the rights holder of the first digital work (e.g., rights holders 402 of eBook 1002). In this manner, the rights holders are incentivized to add referrals to their digital items as a way to potentially earn additional awards. The referral fee may be monetary or non-monetary.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

What is claimed is:

1. A computer-implemented method, comprising:
under control of one or more computers configured with specific executable instructions,
tracking a lending transaction for a digital item in which a first user lends a digital item that is consumable on a first electronic device associated with the first user to a second user for consumption on a second device associated with the second user;
determining whether the second user submits a request to purchase the digital item following receipt of the digital item being lent by the first user; and
paying a referral fee to the first user in an event that the second user purchases the digital item.

2. The computer-implemented method of claim 1, wherein the digital item is an electronic book, and the first electronic device is an electronic book reader device having a user interface that permits a user to loan the electronic book to the second user.

3. The computer-implemented method of claim 1, wherein tracking a lending transaction comprises receiving a request to lend the digital item from the first user and further comprising downloading the digital item to the second device associated with the second user.

4. The computer-implemented method of claim 1, wherein tracking a lending transaction comprises receiving a notification that the digital item was transferred from the first device to the second device.

5. The computer-implemented method of claim 1, wherein tracking a lending transaction comprises storing an identity of the digital item being loaned in association with one or more identities of the first user, the second user, the first electronic device, and the second electronic device.

6. The computer-implemented method of claim 1, wherein determining whether the second user submits a request to purchase the digital item comprises receiving a request from the second user to purchase the digital item and facilitating purchase of the digital item.

7. The computer-implemented method of claim 1, wherein paying the referral fee comprises allocating a portion of proceeds from the purchase of the digital item to the first user.

8. The computer-implemented method of claim 1, wherein paying the referral fee comprises awarding a non-monetary award.

9. A computer-implemented method, comprising:
under control of one or more computers configured with specific executable instructions,
maintaining a record of a digital item;
receiving an indication that an owner of the digital item intends to resell the digital item;
offering the digital item for resale at a sale price;
upon purchase of the digital item by a purchaser, allocating proceeds from the resale to the owner and to one or more rights holders; and
updating the record of the digital item to reflect the resale from the owner to the purchaser.

10. The computer-implemented method of claim 9, wherein the digital item comprises one of an electronic book, an audio item, a video item, a multimedia item, and a graphical item.

11. The computer-implemented method of claim 9, wherein the digital item comprises an electronic book and the rights holders comprise at least one of an author, a publisher, or a distributor.

12. The computer-implemented method of claim 9, further comprising facilitating transfer of access rights to the digital item from the owner to the purchaser.

13. The computer-implemented method of claim 9, further comprising facilitating transfer of the digital item from a storage medium accessible by the owner to a second storage medium accessible by the purchaser.

14. A computer-implemented method, comprising:
under control of one or more computers configured with specific executable instructions,
providing a first digital item for consumption by a user, the first digital item containing a reference to a second digital item that is different than the first digital item;
receiving an indication from the user to purchase the second digital item as a result of interacting with the first digital item; and
upon purchase of the second digital item, paying a referral fee to one or more rights holders of the first digital item.

15. The computer-implemented method of claim 14, wherein the first digital item is an electronic book that contains a link to the second digital item.

16. The computer-implemented method of claim 14, wherein the first digital item is an electronic book and the one or more rights holders comprise an author, a publisher, and a distributor.

17. The computer-implemented method of claim 14, wherein the reference comprises a link and further comprising providing information about the second digital item in response to user activation of the link.

18. The computer-implemented method of claim 14, further comprising, responsive to user interaction with the first digital item, providing a sample of the second digital item.

19. The computer-implemented method of claim 14, further comprising, responsive to user interaction with the first digital item, providing an offer to sell the second digital item.

20. The computer-implemented method of claim 14, wherein the referral fee is a monetary fee.

21. The computer-implemented method of claim 14, wherein the referral fee consists of a portion of proceeds from the purchase.

22. A computer-readable storage media storing computer-readable instructions that, when executed, instruct a processor to perform acts comprising:
receiving a request to purchase a digital item from a purchaser, the request being generated as a result of the purchaser reviewing a loaned version of the digital item using an electronic device, the loaned version of the digital item being lent by a lender; and
allocating a referral fee to the lender.

23. The computer-readable storage media of claim 22, wherein allocating the referral fee comprises allocating a portion of proceeds from the purchase of the digital item.

24. The computer-readable storage media of claim 22, wherein allocating the referral fee comprises awarding a non-monetary award.

25. A computer-readable storage media storing computer-readable instructions that, when executed, instruct a processor to perform acts comprising:
accepting a resale price for a digital item being offered for resale by a reseller;
allocating a portion of proceeds from the resale to both the reseller and one or more rights holders in the digital item.

26. A computer-readable storage media storing computer-readable instructions that, when executed, instruct a processor to perform acts comprising:
receiving a request for a referenced digital item, the request originating as a result of user interaction with an electronic book while using an electronic book reader device, the electronic book containing a reference to the referenced digital item;
providing, for display on the electronic book reader device, information about the referenced digital item along with at least one of a purchase option to purchase the referenced digital item or a sample option to view a sample of the reference digital item;
receiving from the electronic book reader device an indication to purchase the referenced digital item; and
paying a referral fee to one or more rights holders of the electronic book.

27. The computer-readable storage media of claim 26, wherein the reference digital item comprises one of another electronic book, an audio item, a video item, a multimedia item, and a graphical item.

28. The computer-readable storage media of claim 26, wherein the referral fee is a monetary fee.

29. The computer-readable storage media of claim 26, wherein the referral fee consists of a portion of proceeds from the purchase.

30. A computing system for supporting a secondary market for digital items, the computing system comprising:
one or more processors;
memory accessible by the one or more processors;
a lending system stored in the memory and executable by the one or more processors to track lending of a digital item from a first user to a second user and to allocate a referral fee to the first user in an event that the second user purchases the digital item being lent; and
a resale transaction module stored in the memory and executable by the one or more processors to accept a resale price for a digital item being offered for resale by a reseller, the resale transaction module being configured to allocate a portion of proceeds from the resale to both the reseller and one or more rights holders in the digital item.

31. The computing system of claim 30, wherein the referral fee is a monetary fee.

32. The computing system of claim 30, wherein the referral fee consists of a portion of proceeds from the purchases of the digital item by the second user.
